(19) United States
(12) Patent Application Publication
(10) Pub. No.: US 2013/0321448 A1
(43) Pub. Date: Dec. 5, 2013

(54) Lighting control system

(71) Applicants: Tommaso Gritti, Breda (NL); Gianluca Monaci, Eindhoven (NL)

(72) Inventors: Tommaso Gritti, Breda (NL); Gianluca Monaci, Eindhoven (NL)

(73) Assignee: KONINKLIJKE PHILIPS ELECTRONICS N.V., EINDHOVEN (NL)

(21) Appl. No.: 13/995,979

(22) PCT Filed: Dec. 9, 2011
(86) PCT No.: PCT/IB11/55583

§ 371 Date: Jun. 20, 2013

(30) Foreign Application Priority Data
Dec. 22, 2010 (EP) 10196373.4

(51) Int. Cl. G09G 5/10

(52) U.S. Cl. CPC G09G 5/10
USPC 345/589

(57) ABSTRACT

Lighting control system (100) for controlling luminaires (160) to enable illuminating a work surface (180) using the luminaires using the luminaires for rendering an image on the work surface, the lighting control system comprising a controller (120) for obtaining a dataset (102), the dataset comprising an input image (104) and illumination data (106), the illumination data being indicative of an illumination (162) of the work surface obtained by individual ones of the luminaires, a processor (140) for generating, independence on the dataset, drive data (144) for the luminaires for enabling a rendering (164) of the input image on the work surface, the processor being further configured for estimating, in dependence on the drive data and the input image, a rendering error (142) of the rendering, the controller being configured for obtaining a first dataset, the first dataset comprising a first input image and first illumination data, the controller being further configured for instructing the processor to estimate a first rendering error, the controller being further configured for establishing, in dependence on the first rendering error, a second dataset for enabling a second rendering having a lower rendering error than the first rendering error.

### FIELD OF THE INVENTION

The invention relates to a lighting control system for, and a method of controlling luminaires to enable illuminating a work surface using the luminaires for rendering an image on the work surface.

In the fields of lighting and lighting control, there is a clear trend from stand-alone luminaires towards sets of cooperating luminaires that are centrally controllable. For enabling such central control, the luminaires are typically connected to a lighting control system which enables a user to carry out said control using, e.g., a user interface or a remote control device. The luminaires may be connected to the lighting control system via, e.g., a wireless connection such as ZigBee, as described in “ZigBee Technology: Wireless Control that Simply Works”, IEEE 802.15.4 Task Group, obtained from http://www.zigbee.org, or via the luminaires' power supply using so-termed power line communication. Consequently, the lighting control system enables the user to remotely and centrally control the luminaires.

The lighting control system may further facilitate the user's control of the luminaires. For example, the lighting control system may allow a user to select a certain color or light intensity using a user interface, and the lighting control system may then automatically instruct all of the luminaires to provide the particular color or light intensity. Therefore, the user does not need to control each of the luminaires separately.

### BACKGROUND OF THE INVENTION

A lighting control system may also allow for a different sort of control of the luminaires. From WO 02/101702 A2, a system is known for generating control signals for networked lighting systems. The system allows a user to generate or provide an image. The system further includes associating a plurality of light systems with positions in an environment, and using the association of the light systems and positions to convert the image into control signals for the light systems, wherein the light systems generate an effect that corresponds to the image. As such, the image is displayed through the lighting systems.

A problem of WO 02/101702 A2 is that the system provides a rendering on the work surface using the luminaires that is of insufficient quality.

### SUMMARY OF THE INVENTION

It would be advantageous to have a system for, and a method of controlling luminaires for enabling a higher quality rendering on the work surface using the luminaires.

To better address this concern, a first aspect of the invention provides a lighting control system for controlling luminaires to enable illuminating a work surface using the luminaires, the lighting control system comprising a controller for obtaining a dataset, the dataset comprising an input image and illumination data, the illumination data being indicative of an illumination of the work surface obtained by individual ones of the luminaires, a processor for generating, in dependence on the dataset, drive data for the luminaires for enabling a rendering of the input image on the work surface, the processor being further configured for estimating, in dependence on the drive data and the input image, a rendering error of the rendering, the controller being configured for obtaining a first dataset, the first dataset comprising a first input image and first illumination data, the controller being further configured for instructing the processor to estimate a first rendering error, and the controller being further configured for establishing, in dependence on the first rendering error, a second dataset for enabling a second rendering having a lower rendering error than the first rendering error.

In a related aspect of the invention, a method is provided of controlling luminaires to enable illuminating a work surface using the luminaires, the method comprising obtaining a first dataset, the first dataset comprising a first input image and first illumination data, the first illumination data being indicative of a first illumination of the work surface obtained by individual ones of the luminaires, generating, in dependence on the first dataset, first drive data for the luminaires for enabling a first rendering of the first input image on the work surface, estimating, in dependence on the first drive data and the first input image, a first rendering error of the first rendering, and establishing, in dependence on the first rendering error, a second dataset for enabling a second rendering having a lower rendering error than the first rendering error.

In a further related aspect of the invention, a computer program product comprises instructions for causing a processor system to perform the method set forth.

The lighting control system is suitable for controlling luminaires, i.e., light sources arranged in, e.g., lighting fixtures. The luminaires are configured for illuminating a work surface in response to suitable commands from the lighting control system. The work surface may be formed by, e.g., a room, a part of a room, a wall, furniture, etc., and as a consequence, may be two-dimensional or three-dimensional. The system comprises a controller configured for obtaining a dataset, with the dataset being formed by an implicit or explicit combination of an image and illumination data. The image is any suitable visual representation of a scene or an object, and may be two-dimensional or three-dimensional. Furthermore, the illumination data is indicative of the illumination obtained on the work surface by the light emitted from the luminaires and may thus be indicative of, e.g., a shape, intensity or color of the illumination. The illumination data is inherently coupled to a physical configuration of the luminaires, as a change in the physical configuration of the luminaires results in a change of the illumination on the work surface. The illumination data may also take into account the work surface itself, and thus be indicative of, e.g., a color, reflectance or shape of the work surface. As such, the illumination data may represent the actual obtained illumination of the work surface.

The lighting control system further comprises a processor configured for generating drive data for the luminaires. The drive data indicates to a luminaire the illumination it needs to provide, e.g., by indicating a light intensity, a color, etc. The processor generates the drive data using the dataset and thus uses both the image and the illumination data. As such, the processor generates drive data that takes into account the capabilities of the luminaires for rendering the image on the work surface. The processor is further configured for estimating a rendering error of the rendering. The processor estimates the rendering error using both the drive data and the input image. The drive data is indicative of a rendered version of the image on the work surface. The processor takes into account a difference between the image and its rendered version to estimate the rendering error. Hence, the lighting control system does not need to actually provide the drive data to the luminaires and observe a rendering of the image on the work surface to estimate the rendering error. Instead, the lighting control system simulates a rendering of the image on the work surface.

The controller is configured for, during operation, obtaining a first dataset, the first dataset comprising a first input image and first illumination data. The controller instructs the processor to estimate a rendering error of the first input image, i.e., a first rendering error. In accordance with the above described configuration of the processor, the processor thus generates first drive data, and uses the first drive data and the first input image to estimate the first rendering error. The controller is further configured for, during operation, establishing a second dataset using the first rendering error, with the second dataset enabling a second rendering having a lower rendering error than the first rendering. The first rendering error thus determines the particular second dataset that is established by the controller.

The invention is, inter alia, based on the recognition that it may be difficult for a user to accurately judge whether a particular image is suitable for rendering on the work surface using the luminaires. The reason for this is that the rendered image, as perceived by the user, is a result of the light emitted by the luminaires, and hence, partially depends on the physical configuration and capabilities of the luminaires. For example, the user may not be aware that one of the luminaires cannot provide sufficiently saturated colors for rendering a saturated part of the image. Similarly, the user may be aware that one of the luminaires cannot provide sufficient light intensity for rendering a bright part of the image.

Moreover, the rendered image, as perceived by the user, partially depends on the light reflecting properties of the work surface. These properties may not always be suitable for rendering certain images. For example, when a portion of the work surface is green, e.g., formed by a green wall, it is not possible to render a red part of the image on this portion of the work surface. Similarly, when a portion of the work surface is poorly illuminated, e.g., due to obstruction of light by furniture, it is not possible to render a bright part of the image on this portion of the work surface. The user may therefore have difficulty judging the suitability of rendering a particular image on the work surface, i.e., the faithfulness of the rendering with respect to the particular image. Of course, the user may instruct the lighting control system to render the particular image, but if the results are unsatisfactory, he may need to find a further image and also instruct the lighting control system to render the further image to determine whether the further image is more suitable for rendering on the work surface. Disadvantageously, the user may need to repeat the above process for multiple images, which is time consuming and may be unsatisfactory to the user.

The aforementioned measures have the effect that the lighting control system is configured for estimating a suitability of a rendering of an image on a work surface. During operation, a first rendering error of the first input image is estimated, with the first rendering error being indicative of how suitable the rendering of the first image on the work surface is. The lighting control system then establishes a second dataset using the first rendering error that enables a second rendering having a lower rendering error than the first rendering. Thus, the lighting control system automatically establishes a second dataset that is more suitable for rendering on the work surface. Advantageously, when the user provides a first image of a first dataset, the lighting control system may automatically establish a second dataset with a second image that is more suitable for rendering on the work surface using the luminaires. Advantageously, when the first illumination data is associated with a first physical configuration of the luminaires, the lighting control system may automatically establish a second dataset with second illumination data being associated with a second physical configuration of the luminaires that is more suitable for rendering a particular image on the work surface. Advantageously, the user may not need to request an actual rendering of both input images for determining which of both input images is most suitable for rendering on the work surface. Advantageously, the user may not need to manually establish which physical configuration of the luminaires is most suitable for rendering on the work surface.

Optionally, the processor is configured for estimating a second rendering error of the second rendering, and the controller is configured for establishing the second dataset in dependence on the first rendering error and the second rendering error. When establishing the second dataset, the processor takes into account the suitability of the first dataset and the suitability of the second dataset for rendering on the work surface. Advantageously, the processor may compare the first rendering error with the second rendering error to determine which of both rendering errors the lower rendering error is. Advantageously, the processor may take into account a difference between the first rendering error and the second rendering error for establishing a second dataset that provides a sufficiently lower rendering error.

Optionally, the controller is configured for establishing the second dataset by establishing a second input image. The first dataset and the second dataset each comprise different input images. Advantageously, when the user provides a first image, the lighting control system may establish a second image that is more suitable for rendering on the work surface. Advantageously, the lighting control system may not need to establish second illumination data, but may instead include the first illumination data in the second dataset.

Optionally, the controller is configured for accessing a database comprising database images, and for establishing the second input image by selecting the second input image amongst the database images. The second input image is obtained from a database. Advantageously, the controller can compare multiple database images for selecting as the second input image a database image that provides the lowest rendering error.

Optionally, the first input image comprises metadata, and the controller is configured for selecting the second input image amongst the database images in dependence on the metadata. The second input image is obtained from the database in dependence on the metadata. Advantageously, the controller may select the second input image amongst database images that have similar image content as the first input image. Advantageously, the controller may select the second input image amongst database images that are associated with a similar atmosphere or emotion as the first input image.

Optionally, the processor is configured for estimating respective rendering errors of respective renderings of the database images, the controller is configured for calculating, in dependence on the respective rendering errors, a ranking of the database images, and the lighting control system comprises an output for indicating to a user the ranking, and an input for enabling the user to configure, in dependence on the ranking, the selecting of the second input image.

The user is provided with an indication of a ranking of the database images that corresponds to a respective rendering error. As such, the user is provided with information on how suitable a database image is for rendering on the work surface. This allows a user to take into account the rendering error when selecting the second input image. Moreover, the first input image may also be one of the database images, the establishing the second dataset may comprises establishing a second input image that has a lower rendering error than the first input image, and the output may indicate the ranking to the user for enabling the user to select the second input image based on its lower rendering error.

Optionally, the controller is configured for establishing the second input image by modifying the first input image for obtaining as the second input image a modified version of the first input image. The second input image is a modified version of the first input image that has a lower rendering error than the unmodified version of the first input image. Advantageously, the controller may modify the first input image to better match the illumination of the work surface obtained by the individual ones of the luminaires. Advantageously, the controller may modify the first input image to take into account deficiencies, irregularities, non-uniformities, etc., of the illumination of the work surface.

Optionally, the modifying the first input image comprises at least one of: resizing, cropping, modifying brightness, modifying contrast, modifying saturation, and modifying hue, of the first input image. Said modifications are particularly efficient ways of modifying the first input image.

Optionally, the controller is configured for analyzing the first rendering error for obtaining modification data indicative of the modified version of the first input image, and the controller is further configured for modifying the first input image in dependence on the modification data. The modification data thus represents a result of an analysis of the first rendering error, which is then used by the controller to modify the first input image. Advantageously, by modifying the first input image based on an analysis of the first rendering error, it may not be needed to explicitly estimate a second rendering error as the analysis and/or the modification data is already indicative of a lower rendering error.

Optionally, the first illumination data is indicative of a first illumination of the work surface obtained by a first physical configuration of the luminaires, second illumination data is indicative of a second illumination of the work surface obtained by a second physical configuration of the luminaires, and the controller is configured for establishing the second dataset by establishing the second illumination data.

The first dataset and the second dataset each comprise different illumination data. Advantageously, when the first illumination data is provided, the lighting control system may establish second illumination data that is more suitable for rendering on the work surface. Advantageously, the lighting control system may not need to establish a second input image, but may instead include the first input image in the second dataset.

Optionally, establishing the second illumination data comprises at least one of: receiving the second illumination data, and generating the second illumination data in dependence on the first rendering error.

Optionally, the controller is configured for analyzing the first rendering error for obtaining configuration data indicative of the second physical configuration of the luminaires. The configuration data is indicative of how the luminaires are to be physically configured for obtaining a lower rendering error. Advantageously, the system may indicate the configuration data to a user for enabling the user to physically adjust the physical configuration of the luminaires for obtaining the second physical configuration.

Optionally, at least one of the luminaires is remotely adjustable in orientation and/or position, and the controller is configured for remotely adjusting the at least one of the luminaires in dependence on the configuration data for physically establishing the second physical configuration of the luminaires. Advantageously, the user does not need to manually adjust the luminaires for obtaining the second physical configuration.

It will be appreciated by those skilled in the art that two or more of the above-mentioned embodiments, implementations, optional features, and/or aspects of the invention may be combined in any way deemed useful.

Modifications and variations of the method and/or the computer program product, which correspond to the described modifications and variations of the lighting control system, can be carried out by a person skilled in the art on the basis of the present description.

A person skilled in the art will appreciate that the invention may be applied to multi-dimensional images, e.g., to two-dimensional (2-D), three-dimensional (3-D) or four-dimensional (4-D) images. A dimension of the multi-dimensional image may relate to time. For example, a three-dimensional image may comprise a time domain series of two-dimensional images.

The invention is defined in the independent claims. Advantageous embodiments are defined in the dependent claims.

### BRIEF DESCRIPTION OF THE DRAWINGS

These and other aspects of the invention are apparent from and will be elucidated with reference to the embodiments described hereinafter. In the drawings,

FIG. 1 shows a lighting control system configured for controlling luminaires to enable illuminating a work surface using the luminaires;

FIG. 2 shows a lighting control system configured for accessing a database comprising database images and for indicating to a user a ranking of the database images;

FIG. 3 shows an example of drive data and illumination data;

FIG. 4 shows an example of an input image;

FIG. 5 shows an example of a rendering on a work surface; and

FIG. 6 shows a method of controlling luminaires to enable illuminating a work surface using the luminaires.

### DETAILED DESCRIPTION OF EMBODIMENTS

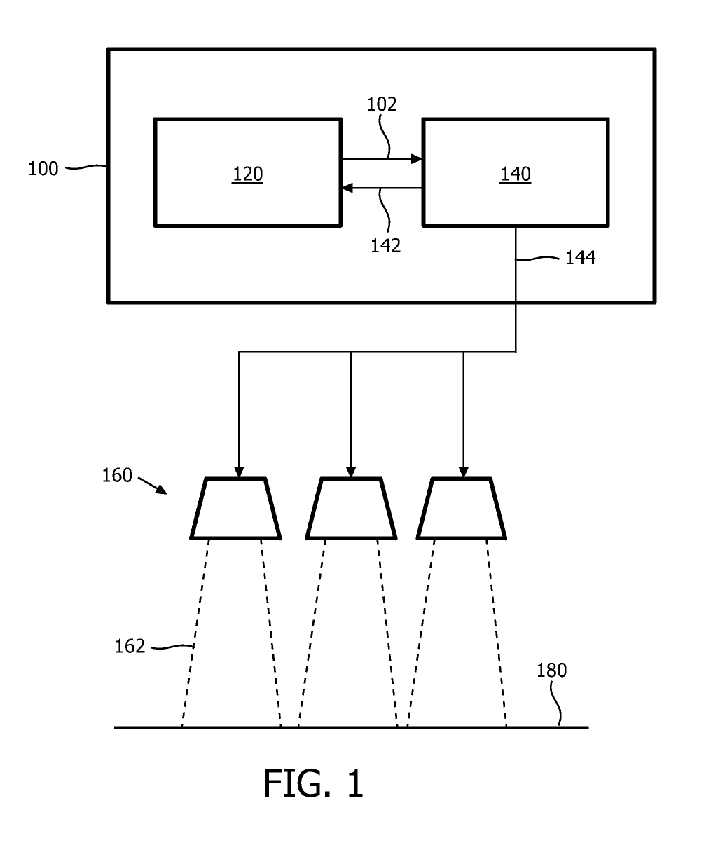

FIG. 1 shows a lighting control system 100 for controlling luminaires 160 to enable illuminating a work surface 180 using the luminaires 160. The lighting control system 100 comprises a controller 120 for obtaining a dataset 102. The dataset 102 comprises an input image and illumination data, with the illumination data being indicative of an illumination 162 of the work surface 180 obtained by individual ones of the luminaires 160. The lighting control system 100 further comprises a processor 140 for generating, in dependence on the dataset 102, drive data 144 for the luminaires for enabling a rendering of the input image on the work surface. For that purpose, the processor 140 is shown to be connected to the controller 120 for obtaining the dataset 102. Furthermore, the processor 140 is shown to be connected to the luminaires 160 for providing the drive data 144 to the luminaires 160. The processor 140 is configured for estimating, in dependence on the drive data 144 and the input image 102, a rendering error 142 of the rendering, and the controller 120 is configured for obtaining the rendering error 142 from the processor 140. For that purpose, the controller 120 is shown to be connected to the processor 140.

During operation, the controller 120 obtains a first dataset, the first dataset comprising a first input image and first illumination data, and instructs the processor 140 to estimate a first rendering error. Furthermore, the controller 120 establishes, in dependence on the first rendering error, a second dataset for enabling a second rendering having a lower rendering error than the first rendering error.

It is noted that the term luminaire refers to a lamp, a light fixture or a light module. The luminaire comprises a light source, e.g., a lamp, and may comprise an optic. The luminaire may be part of an installed lighting equipment or lighting infrastructure.

The term drive data refers to data that indicates to one of the luminaires or all of the luminaires what type of light should be emitted. The drive data may be indicative of a color hue, a color saturation, a light intensity, a temporal aspect of the light, etc.

The term work surface refers to a surface that is to be illuminated by the luminaires. The work surface may be formed by, e.g., a room, a part of a room, a wall, furniture, etc., and as a consequence, may be two-dimensional or three-dimensional.

The term rendering, and specifically rendering an image, refers to a visual representation of the image using the luminaires. As such, the luminaires emit light that illuminates the work surface, with the resulting illumination of the work surface being a visual representation of the image. It will be appreciated that the rendering is typically only a very approximate representation of the image, as the luminaires are typically not able to represent all details of the image. A reason for that is that there are typically significantly less luminaires than details within the image. Similarly, the color range and/or light intensity range of the luminaires may be insufficient for perfectly representing the image.

It is noted that enabling a rendering, and specifically enabling a rendering of an image, refers to generating drive data that may be used by the luminaires for rendering the image. It will be appreciated that the drive data does not actually need to be provided to the luminaires, i.e., an actual rendering of the image is neither needed nor implied. Consequently, the lighting control system may not need to be actually connected to luminaires, but may rather only generate drive data for, e.g., the purpose of establishing the second dataset.

The term illumination data refers to data that is indicative of an illumination obtained on the work surface by the light emitted from the luminaires. The illumination data may also take into account the work surface itself, and thus may represent the actual obtained illumination of the work surface. For example, the illumination data may comprise a plurality of images showing the illumination that respective luminaires provide on the work surface. As such, for each of the luminaires, the illumination data comprises at least one image that shows the illumination that the luminaire is able to provide on the work surface. The illumination data therefore effectively forms a light palette composed of images showing the effect of the luminaires on the work surface.

The term dataset refers to an explicit or implicit combination of an image and illumination data. For example, the image and the illumination data may be stored in a single computer file or be associated with each other on a computer file system, thus forming an explicit combination. However, the combination may also be implicit, and may be mainly or only apparent from the fact that the processor 140 uses an image and illumination data together, i.e., in combination, for generating the drive data 144.

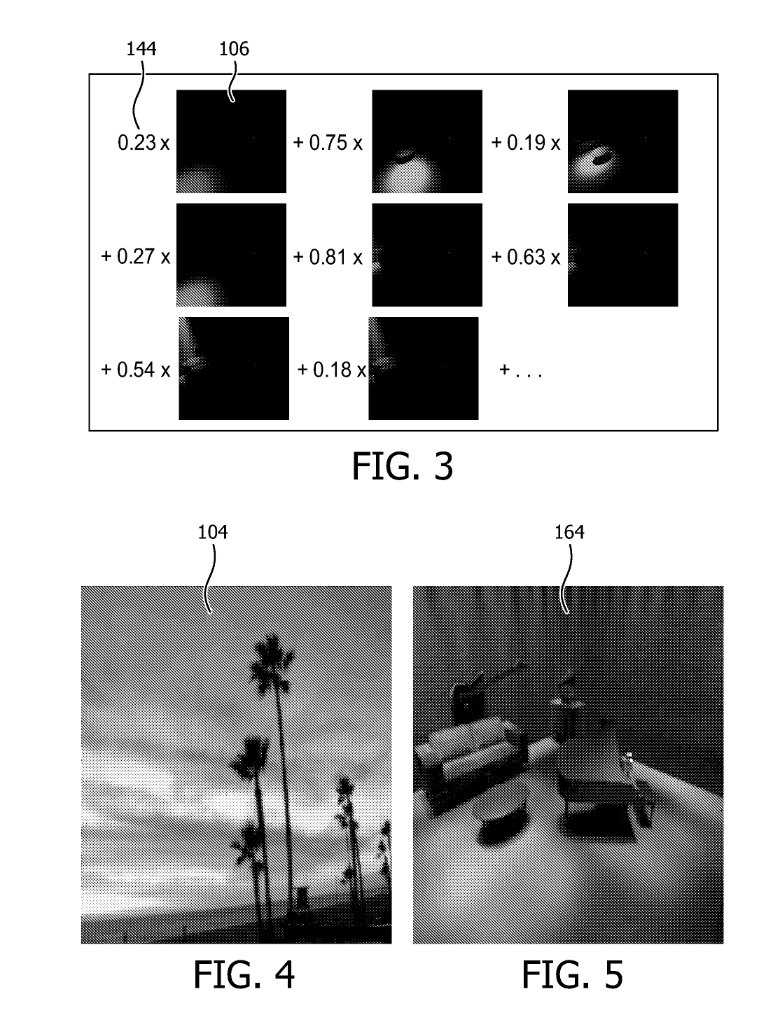

The controller 120 obtains a first dataset, and instructs the processor 140 to estimate a first rendering error using the first dataset. The first dataset comprises a first input image and first illumination data. The first input image may be two-dimensional image 104 as shown in FIG. 4. The first illumination data may comprise a set of images 106 as shown in FIG. 3, corresponding to the illumination 162 of the work surface 180 provided by each luminaire when the luminaire is activated fully, i.e., emits light at its maximum intensity. Of course, the luminaires 160 may be capable of emitting colored light using multiple color primaries, e.g., using red, green and blue light sources, or using only one particular color primary, e.g., using a red light source. Hence, multiple images may exist within the set of images 106 for each luminaire showing the illumination 162 that the luminaire is able to provide on the work surface 180 with each of the color primaries of the luminaire.

The processor 140 generates first drive data using the first input image and the first illumination data. For generating the first drive data, an image approximation technique may be used. For example, the first input image may be approximated as a weighted sum of the images of the first illumination data. Here, the weights correspond to the amount of activation of each luminaire, i.e., are bound between 0, i.e., no activation, and 1, i.e., full activation. As such, generating the first drive data is formulated as a classical constrained regression problem that can be solved using, e.g., non-negative least square fitting or any other suitable method known from the field of regression analysis. As a result, weights are obtained that correspond to an activation of each of the luminaires 160, thus forming the first drive data. An example of drive data 144 is shown in FIG. 3. Alternatively, a point-by-point method may be used, as disclosed in WO 2008/104927 A2. Alternatively, any other suitable technique that is known from the field of lighting control may be used.

The processor 140 uses the first drive data and the first input image to estimate the first rendering error. The first drive data is representative of a rendered version of the first input image, i.e., one that is indicative of an actual rendering of the first input image on the work surface 180. The processor 140 may explicitly generate the rendered version of the first input image, i.e., simulate its actual rendering, by, e.g., computing the weighted sum of the images of the first illumination data. The processor 140 may then estimate the first rendering error by determining a difference between the rendered version of the first input image and the first input image. For that purpose, the processor 140 may apply an error function. For example, the processor 140 may calculate a Mean-Squared Error (MSE) between image elements of the rendered version of the first input image and corresponding image elements of the first input image. The processor 140 may then calculate a Peak Signal-to-Noise Ratio (PSNR) of the MSE to determine the first rendering error. It will be appreciated that MSE and PSNR are known in the fields of statistics and image analysis, and that alternatively, any other suitable error function from those fields may be used.

The first rendering error may be calculated in a perceptually uniform color space, e.g., CIELAB, as is known from the field of color science, for obtaining a first rendering error that corresponds to a user's perception of the difference between the image and its rendering on the work surface 180. It will be appreciated that the processor 140 may not explicitly generate the rendered version of the first input image, but may rather obtain the first rendering error directly while generating the drive data 144. For example, when using a non-negative least square fitting, an error term is minimized, which may be directly used as the first rendering error. It will be appreciated that the above is also applicable to rendering errors in general, e.g., a second rendering error.

The controller 120 uses the first rendering error to establishing a second dataset for enabling a second rendering having a lower rendering error than the first rendering error. The controller 120 may establish the second dataset by establishing a second input image. Furthermore, the controller 120 may include the first illumination data in the second dataset, or may alternatively also establish second illumination data. Thus, the controller 120 establishes a second input image to achieve a lower rendering error.

The establishing the second input image may comprise modifying the first input image for obtaining as the second input image a modified version of the first input image. For example, the controller 120 may resize, crop, modifying a brightness, modifying a contrast, modifying a saturation, or modifying a hue of the first input image to obtain the second input image. For obtaining a lower rendering error, the controller 120 may iteratively modify the first input image, and estimate a rendering error corresponding to the modified version of the first input image until the rendering error is lower than the first rendering error. Thus, the second input image may be established at the end of an iteration in which one or more intermediate images have been generated by modifying the first input image.

Alternatively, the controller 120 may be configured for analyzing the first rendering error for obtaining modification data indicative of the modified version of the first input image, and for modifying the first input image in dependence on the modification data. The first rendering error may be indicative of how the first input image may be modified to obtain a lower rendering error. For example, the first rendering error may be estimated by subtracting the first input image from the rendered version of the first input image, with the first rendering error thus being a first error image. It will be appreciated that the first error image may be analyzed to obtain modification data, for example, by detecting areas with a high error. An area with a high error may indicate that the particular portion of the work surface can only be poorly illuminated. The first input image may then be modified by cropping or resizing the first input image such that relatively dark areas of the first input image are mapped to said areas with the high error. Thus, the second input image may be established by modifying the first input image and without estimating a second rendering error.

The controller 120 may also establish the second dataset by establishing the second illumination data. Furthermore, the controller 120 may include the first input image in the second dataset, or may alternatively also establish a second input image. Thus, the controller 120 establishes second illumination data to achieve a lower rendering error. The illumination data 106 is inherently coupled to a physical configuration of the luminaires 160, i.e., to a configuration of, e.g., a position, an orientation, a type, a number, etc., of the luminaires 160. Hence, when the physical configuration of the luminaires 160 changes, the illumination data 106 needs to be adapted to said change in physical configuration. The first illumination data is indicative of a first illumination of the work surface 180 obtained by a first physical configuration of the luminaires 160, and second illumination data is indicative of a second illumination of the work surface 180 obtained by a second physical configuration of the luminaires 160. Thus, the controller 120 establishes, as second illumination data, data that is inherently coupled to a second physical configuration of the luminaires 160.

The controller 120 may establish the second illumination data by firstly analyzing the first rendering error for obtaining configuration data indicative of the second physical configuration of the luminaires. The first rendering error may be indicative of how the physical configuration of the luminaires 160 may be modified to obtain a lower rendering error. For example, the first rendering error may be estimated by subtracting the first input image from the rendered version of the first input image, with the first rendering error thus being a first error image. It will be appreciated that the first error image may be analyzed to obtain configuration data, for example by detecting areas with a high error. An area with a high error may indicate that the particular portion of the work surface can only be poorly illuminated. Hence, the configuration data may indicate that an additional luminaire is needed for better illuminating the particular portion of the work surface. Similarly, the configuration data may indicate that the luminaires 160 may need to be re-positioned to allow for a more homogenous illumination of the work surface 180. Also, the configuration data may indicate that a different type of luminaire may be needed to obtain a sufficient color saturation for rendering the image on the work surface 180.

It will be appreciated that, next to analyzing the first rendering error, the controller 120 may obtain its configuration data from a plurality of input images and their corresponding rendering errors for obtaining configuration data indicative of the second physical configuration of the luminaires 160 that achieves, on average, a lower rendering error for the plurality of input images.

The controller 120 may be configured for, after having obtained the configuration data, establishing the second illumination data by enabling physically establishing the second physical configuration of the luminaires. For that purpose, the lighting control system 100 may indicate the configuration data to a user for enabling the user to physically establish the second physical configuration of the luminaires. For example, the lighting control system 100 may comprise a display or be connected to a display, and may then show the configuration data on the display. Showing the configuration data may comprise, e.g., showing an image of the work surface 180 and indicating a position where an additional luminaire is needed, indicating a luminaire that needs to be re-positioned, indicating a luminaire that needs to be replaced by a different type of luminaire, etc. As such, the lighting control system 100 may provide instructions to the user for enabling the user to physically establish the second physical configuration of the luminaires 160.

At least one of the luminaires 160 may also be remotely adjustable in orientation and/or position, and the controller 120 may be configured for remotely adjusting the at least one of the luminaires 160 in dependence on the configuration data for physically establishing the second physical configuration of the luminaires 160. As such, the lighting control system 100 may physically establish the second physical configuration of the luminaires without a need for a user to manually physically establish said configuration.

The controller 120 may be configured for establishing the second illumination data by receiving the second illumination data, e.g., from the user or from an illumination data generator. The controller 120 may receive the second illumination data after the second physical configuration of the luminaires was physically established. The illumination data generator may employ a known method for capturing the illumination 162 obtained on the work surface 180 by the light emitted from the luminaires 160. For example, the illumination data generator may comprise a camera and employ a so-termed palette acquisition process that comprises flashing each color primary of each luminaire individually at maximum intensity, with the camera capturing an image of the illumination 162 obtained on the work surface 180. At the end of the process, a light palette composed of images showing the illumination 162 of each color primary of each luminaire on the work surface 180 is available. These images may be stored as so-termed basic elements within the illumination data that the lighting control system 100 can then use to simulate the illumination 162 of each luminaire 160 on the work surface 180. Using these images, it is possible to render any image using the luminaires 160. It will be appreciated, that any other method or system may be used as well for generating the second illumination data, and that the first illumination data may also have been generated in a same or similar manner.

The controller 120 may also generate the second illumination data in dependence on the first rendering error. For that purpose, the controller 120 may first analyze the first rendering error for obtaining configuration data indicative of the second physical configuration of the luminaires, and then generate the second illumination data in dependence on the configuration data. Said generating may comprise, when, e.g., the configuration data indicates that an additional luminaire is needed for better illuminating a particular portion of the work surface 180, estimating an image showing the illumination obtained by the added luminaire on the work surface 180 and including the image in the second illumination data. As such, it may not be needed to visually observe the luminaires 180, e.g., using a camera, for obtaining the second illumination data.

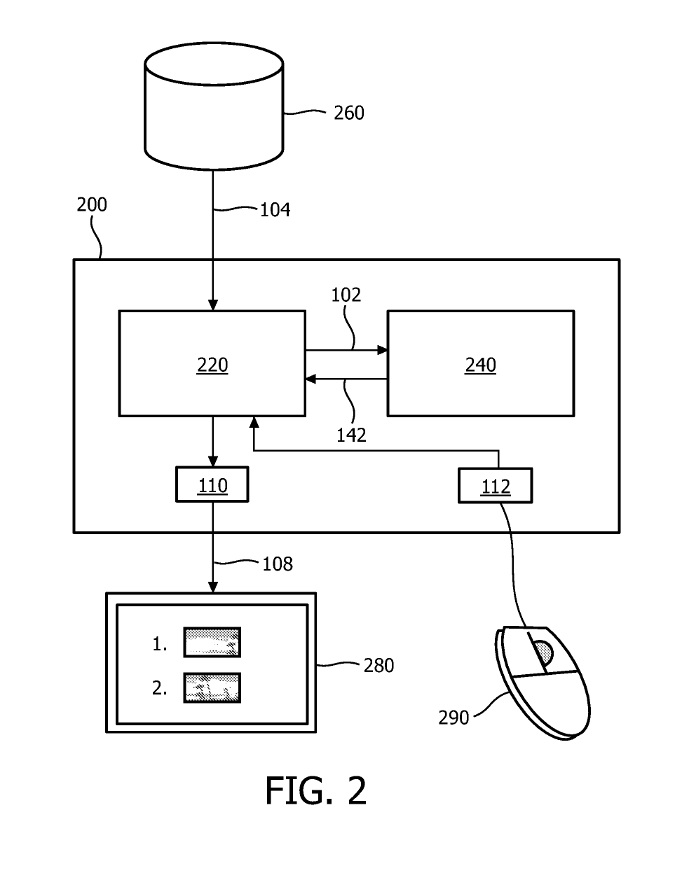

FIG. 2 shows a lighting control system 200 comprising a controller 220 and a processor 240. It will be appreciated that the configuration of the controller 120 and processor 140 of FIG. 1 may also be applicable to the controller 220 and processor 240 of FIG. 2, with the exception of the following aspects. The controller 220 is configured for accessing a database 260 comprising database images. For that purpose, the controller 220 is connected to the database 260. The lighting control system 200 further comprises an output 110 that is shown to be connected internally, i.e., within the lighting control system 200, to the controller 220, and externally to a display 280. The lighting control system 200 further comprises an input 112 that is shown to be connected internally to the controller 220, and externally to a user input device 290.

During operation, the controller 220 establishes the second dataset by establishing the second input image. The establishing the second input image may comprise selecting the second input image amongst the database images. The selecting the second input image may comprise selecting a candidate input image amongst the database images, obtaining its rendering error from the processor 240, and selecting the candidate input image as the second input image when its rendering error is lower than the first rendering error. If its rendering error is not lower than the first rendering error, the controller 220 may then select another candidate input image amongst the database images, and repeat the above steps until a particular candidate input image is selected that provides a lower rendering error. Consequently, the particular candidate input image is selected as the second input image.

The controller 220 may be configured for instructing the processor 240 to estimate rendering errors of the database images. It will be appreciated that the database images may be a subset of all the available database images stored within the database 260. Using the rendering errors, the controller 220 may calculate a ranking of the database images. The ranking may thus indicate which of the database images has the lowest rendering error, and which has the highest rendering error. Thus, the ranking is indicative of a suitability of a database image for rendering on the work surface 180 using the luminaires 160. The controller 220 may be configured for displaying the ranking on the display 280 via the output 110. The display 280 may, for example, show a database image together with its ranking.

The first input image and the second input image may both be part of the database images. Thus, the establishing the second input image may comprise using the first rendering error to select as the second input image a database image that has a lower rendering error than the first rendering error. The controller 220 therefore establishes as the second input image a database image that has a lower rendering error than another database image, i.e., the first input image. Consequently, the first input image thus does not need to be provided by, e.g., a user, but may rather be one of the database images. The lighting control system 200 thus predicts how well each database image can be rendered on the work surface using the luminaires. The database images are automatically ranked, with those achieving a higher rank being better suited for the available luminaires 160 and work surface 180.

For selecting the second input image amongst the database images, the controller 220 may use metadata that may be included or otherwise associated with the first input image for selecting the second input image amongst the database images in dependence on the metadata. As such, the controller 220 may select the second input image amongst a subset of the database images that have a same or similar metadata. For example, the metadata may indicate that the first input image shows a sunset. The controller 220 may select the second input image amongst other database images that also show a sunset. Similarly, the metadata may indicate that the first input image is associated with the emotion ‘cheerful’. Thus, the controller 220 may select the second input image amongst other database images that are associated with the emotion ‘cheerful’.

The controller 220 may also be configured for allowing a user to select the second input image. For that purpose, the user may use the user input device 290 to indicate, e.g., via a pointer shown on the display 280, which of the database images 280 is to be selected as the second input image. Since the user is provided with the ranking of the database images, the user may select a database image as the second input image that has a lower rendering error than the first rendering error. Although not shown in FIG. 2, the processor 240 may also be configured for actually providing the drive data 144 corresponding to the second input image to the luminaires 160 for providing the rendering of the second input image on the work surface 180. Thus, after selecting the second input image, the second input image is rendered on the work surface 180 using the luminaires 160. It is noted that the first input image is typically not rendered on the work surface 180.

The database 260 may be an external database, as is shown in FIG. 2. However, the database 260 may also be an internal database, i.e., may be part of the lighting control system 200. The database 260 may also be an Internet database formed by a web-service such as “Flickr”, http://www.flickr.com/, or “Google Images”, http://www.google.com/imghp. Thus, accessing the database may comprise searching the Internet database. For that purpose, the lighting control system 200 may be connected to the Internet. The searching may comprise searching for a keyword, e.g., as provided by the user. The keyword may be obtained from the metadata associated with the first input image.

It will be appreciated that that the invention may be applied as an automatic recommendation system that operates in combination with a system capable of rendering visual content, i.e., images, in an arbitrary lighting installation, i.e., using arbitrary luminaires. Hence, the lighting control system may not actually provide the drive data to the luminaires, but instead generate the drive data only for the purpose of estimating a rendering error that can be used for ranking images in accordance with their rendering error. The automatic recommendation system may incorporate functionality that searches and suggests images that can be better rendered on the work surface given the available luminaires.

FIG. 4 shows an example of an input image. FIG. 5 shows an example of an actual rendering of the input image on a work surface using the luminaires.

Moreover, the invention may also be applied to video sequence. Hence, the first input image may represent a frame of a first video sequence, and the second input image may represent a frame of a second video sequence. To calculate the rendering errors, the system may also take into account more frames. For example, the first rendering error may be based on a sub-sampling of frames of the first video sequence, and the second rendering error may be based on a same sub-sampling of frames of the second video sequence.

The invention may also be applied to enabling a rendering of a three dimensional volumetric input image within a room comprising luminaires. For example, a detail within a middle of the input image may be rendered using a luminaire that is arranged within the middle of the room for illuminating, e.g., a furniture in the middle of the room, a detail on top of the three dimensional input image may be rendered using a luminaire that is arranged near the ceiling of the room for illuminating the ceiling, etc. Similarly, the invention may also be applied to enabling a rendering of a three dimensional input image formed by a two dimensional image and a depth map. Here, the depth map may indicate a distance to a camera of a certain portion of the two dimensional image. For example, image portions having large depth values may be rendered with luminaires at a back of a room, image portions having small depth values may be rendered with luminaires at a front of a room, etc.

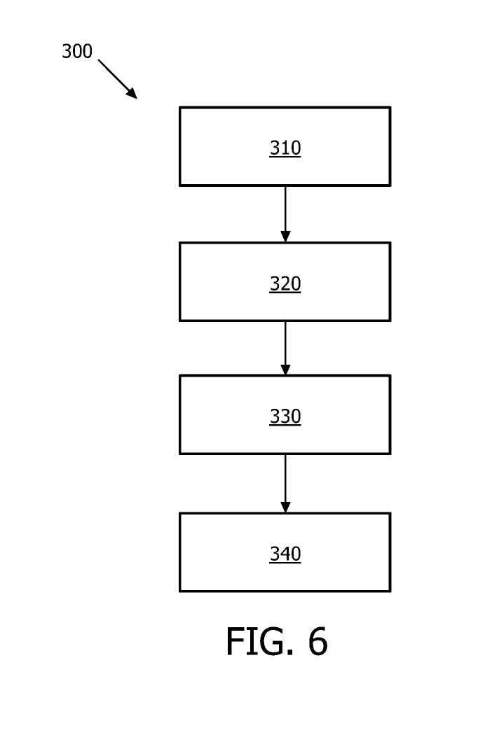

FIG. 6 shows a method 300 of controlling luminaires to enable illuminating a work surface using the luminaires, the method comprising obtaining 310 a first dataset, the first dataset comprising a first input image and first illumination data, the first illumination data being indicative of a first illumination of the work surface obtained by individual ones of the luminaires, generating 320, in dependence on the first dataset, first drive data for the luminaires for enabling a first rendering of the first input image on the work surface, estimating 330, in dependence on the first drive data and the first input image, a first rendering error of the first rendering, and establishing 340, in dependence on the first rendering error, a second dataset for enabling a second rendering having a lower rendering error than the first rendering error.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Lighting control system for controlling luminaires to enable illuminating a work surface using the luminaires, the lighting control system comprising:
a controller for obtaining a dataset, the dataset comprising an input image and illumination data, the illumination data being indicative of an illumination of the work surface obtained by individual ones of the luminaires;
a processor for generating, in dependence on the dataset, drive data for the luminaires for enabling a rendering of the input image on the work surface, the processor being further configured for estimating, in dependence on the drive data and the input image, a rendering error of the rendering;
the controller being configured for obtaining a first dataset, the first dataset comprising a first input image and first illumination data, the controller being further configured for instructing the processor to estimate a first rendering error;
the controller being further configured for establishing, in dependence on the first rendering error, a second dataset for enabling a second rendering having a lower rendering error than the first rendering error.

2. Lighting control system according to claim 1, wherein the processor is configured for estimating a second rendering error of the second rendering, and the controller is configured for establishing the second dataset in dependence on the first rendering error and the second rendering error.

3. Lighting control system according to claim 1, wherein the controller is configured for establishing the second dataset by establishing a second input image.

4. Lighting control system according to claim 3, wherein the controller is configured for:
accessing a database comprising database images; and
establishing the second input image by selecting the second input image amongst the database images.

5. Lighting control system according to claim 4, wherein the first input image comprises metadata, and the controller is configured for selecting the second input image amongst the database images in dependence on the metadata.

6. Lighting control system according to claim 4, wherein the processor is configured for estimating respective rendering errors of respective renderings of the database images, the controller is configured for calculating, in dependence on the respective rendering errors, a ranking of the database images, and the lighting control system comprises:
an output for indicating to a user the ranking; and
an input for enabling the use to configure, in dependence on the ranking, the selecting of the second input image.

7. Lighting control system according to claim 3, wherein the controller is configured for establishing the second input image by modifying the first input image for obtaining as the second input image a modified version of the first input image.

8. Lighting control system according to claim 7, wherein the modifying the first input image comprises at least one of: resizing cropping, modifying brightness, modifying contrast, modifying saturation, and modifying hue, of the first input image.

9. Lighting control system according to claim 7, wherein the controller is configured for analyzing the first rendering error for obtaining modification data indicative of the modified version of the first input image, and the controller is further configured for modifying the first input image in dependence on the modification data.

10. Lighting control system according to claim 1, wherein the first illumination data is indicative of a first illumination of the work surface obtained by a first physical configuration of the luminaires, second illumination data is indicative of a second illumination of the work surface obtained by a second physical configuration of the luminaires, and the controller is configured for establishing the second dataset by establishing the second illumination data.

11. Lighting control system according to claim 10, wherein establishing the second illumination data comprises at least one of: receiving the second illumination data, and generating the second illumination data in dependence on the first rendering error.

12. Lighting control system according to claim 10, wherein the controller is configured for analyzing the first rendering error for obtaining configuration data indicative of the second physical configuration of the luminaires.

13. Lighting control system according to claim 12, wherein at least one of the luminaires is remotely adjustable in orientation and/or position, and the controller is configured for remotely adjusting the at least one of the luminaires in dependence on the configuration data for physically establishing the second physical configuration of the luminaires.

14. A method of controlling luminaires to enable illuminating a work surface using the luminaires, the method comprising:
obtaining a first dataset, the first dataset comprising a first input image and first illumination data, the first illumination data being indicative of a first illumination of the work surface obtained by individual ones of the luminaires;
generating, in dependence on the first dataset, first drive data for the luminaires for enabling a first rendering of the first input image on the work surface;
estimating, in dependence on the first drive data and the first input image, a first rendering error of the first rendering; and
establishing, in dependence on the first rendering error, a second dataset for enabling a second rendering having a lower rendering error than the first rendering error.

15. A computer program product comprising instructions for causing a processor system to perform the method according to claim 14.
